(19) United States
(12) Patent Application Publication
(10) Pub. No.: US 2011/0266892 A1
(43) Pub. Date: Nov. 3, 2011

(54) VIBRATION GENERATING DEVICE

(75) Inventor: Tomokuni WAUKE, Miyagi-Ken (JP)

(73) Assignee: ALPS ELECTRIC CO., LTD., Tokyo (JP)

(21) Appl. No.: 13/082,224

(22) Filed: Apr. 7, 2011

(30) Foreign Application Priority Data
Apr. 28, 2010 (JP) 2010-103383

(51) Int. Cl. H02K 33/00

(52) U.S. Cl. 310/25

(57) ABSTRACT

A vibration generating device includes a coil wound around an outer peripheral surface of a core, a vibrator vibrating due to a magnetic field generated by the coil, a magnetic field forming unit having a pair of magnets oppositely disposed at both surfaces of the vibrator so that the same polarities face each other or one magnet disposed at one side surface of the vibrator, and an elastic support member for supporting the vibrator so that the vibrator is capable of freely vibrating, wherein a vibrating direction of the vibrator is set to be parallel to a fixed surface of the device, by means of a magnetic flux generated by the magnetic field forming unit.

This application claims benefit of Japanese Patent Application No. 2010-103383 filed on Apr. 28, 2010 which is hereby incorporated by reference.

### BACKGROUND OF THE INVENTION

1. Field of the Invention

The present invention relates to a vibration generating device, and more particularly to a vibration generating device which is suitable for being loaded on and used for a portable apparatus.

2. Description of the Related Art

Generally, in a portable apparatus such as a cellular phone and a game controller, a vibration generating device for giving various sensations during use to a user is included.

In such a portable apparatus, the entire housing tends to be slimmer, and there is an increasing demand for slimmer designs for components included therein.

Though there is also a demand for a slim design for a vibration generating device, if a vibrating direction is set to be a thickness direction, there is a problem in that a slimmer design results in a smaller vibration space in the housing, and a great vibrating force cannot be set therein.

Thus, it has been proposed to set a vibrating direction not to be a thickness direction of the housing but to be within a plane orthogonal to the thickness direction (for example, see Japanese Unexamined Patent Application Publication No. 2003-117489).

### SUMMARY OF THE INVENTION

However, in the conventional vibrating body disclosed in Japanese Unexamined Patent Application Publication No. 2003-117489, the entire outer periphery of an axially moving cylindrical magnet is formed to be surrounded by a cylindrical coil, and thus there is a limit on decreasing the size of the vibrating body in a radial direction (also corresponding to a thickness direction). Also, since a spring for supporting vibrations of the vibrating body is also formed with a coil spring, there is a limit on decreasing the size of the spring in a radial direction (also corresponding to a thickness direction). Due to this point, in the conventional example, there is a limit on decreasing the size of the entire configuration in the thickness direction.

The invention is made in consideration of the above point, and it is desirable to provide a vibration generating device of which the entire configuration may have a small size in a thickness direction, which can obtain a large vibration, and which can give vibrations with a plurality of large frequencies.

In a first aspect of the invention, there is provided a vibration generating device, which includes a coil wound around an outer peripheral surface of a core; a vibrator vibrating due to a magnetic field generated by the coil; a magnetic field forming unit having a pair of magnets disposed oppositely at both surfaces of the vibrator so that the same polarities face each other or one magnet disposed at one side surface of the vibrator; and an elastic support member for supporting the vibrator so that the vibrator is capable of freely vibrating, wherein a vibrating direction of the vibrator is set to be parallel to a fixed surface of the device, by means of a magnetic flux generated by the magnetic field forming unit.

In the first aspect of the invention as configured above, since the magnets of the magnetic field forming unit are disposed at the side position of the vibrator, it is possible to decrease the size of the entire configuration in a thickness direction. Also, it is possible to increase a vibration of the vibrator in a direction parallel to the fixed surface of the device.

Also, in a second aspect of the invention, there is provided a vibration generating device, which includes a coil wound around an outer peripheral surface of a core; a first vibrator vibrating due to a magnetic field generated by the coil; a magnetic field forming unit having a pair of magnets oppositely disposed at both surfaces of the first vibrator so that the same polarities face each other or one magnet disposed at one side surface of the vibrator; a first elastic support member for supporting the first vibrator so that the first vibrator is capable of freely vibrating; a second vibrator to which the magnetic field forming unit is connected and which vibrates by receiving a repulsive force caused by interaction of the magnetic fields; and a second elastic support member for supporting the second vibrator so that the second vibrator is capable of freely vibrating, wherein vibrating directions of the first vibrator and the second vibrator are set to be parallel to a fixed surface of the device, and vibrations with different frequencies are generated in accordance with the first elastic support member and the second elastic support member.

In the second aspect of the invention as configured above, since the magnets of the magnetic field forming unit are disposed at the side position of the vibrator, it is possible to decrease the size of the entire configuration in a thickness direction, and it is also possible to increase vibrations of the vibrator caused by two kinds of frequencies in a direction parallel to the fixed surface of the device.

In addition, in a third aspect of the invention, the first elastic support member and the second elastic support member may be made of a spring member bent a plurality of times, at least one end of which is fixed to a housing, at least another end of which is connected to the first vibrator or the second vibrator, in addition to the second aspect.

In the third aspect of the invention as configured above, since the spring member is bent several times, it is possible to decrease the size of the entire configuration in a thickness direction, and it is also possible to increase a vibration of the vibrator in a direction parallel to the fixed surface of the device.

In a fourth aspect of the invention, there is provided a vibration generating device, which includes a housing; and a vibrator supported in the housing by an elastic support member so that the vibrator is capable of freely vibrating, the vibrator vibrating due to a propulsive force generated by a magnetic field, wherein the elastic support member is made of a spring member bent into a bellows shape in a vibrating direction of the vibrator.

In the fourth aspect of the invention as configured above, since the elastic support member is made of a spring member bent into a bellows shape in a vibrating direction of the vibrator, it is possible to decrease the size of the entire configuration in a thickness direction, and it is possible to increase a vibration of the vibrator in a direction parallel to the fixed surface of the device.

According to the invention, it is possible to form the entire configuration with a small size in a thickness direction, give a large vibration, and give vibrations with a plurality of large frequencies.

### BRIEF DESCRIPTION OF THE DRAWINGS

FIG. 1 is an exploded perspective view showing a first embodiment of a vibration generating device according to the invention;

FIG. 2 is a perspective view showing an assembled state of the embodiment shown in FIG. 1, except for an upper case;

FIG. 3 is a sectional view taken along the line 3-3 of FIG. 2;

FIG. 4 is a sectional view taken along the line 4-4 of FIG. 2;

FIG. 5 is a graph showing the relation between vibration frequency and vibrating force in the embodiment of FIG. 1; and

FIG. 6 is a sectional view, which the same as FIG. 4, showing another embodiment.

### DESCRIPTION OF THE PREFERRED EMBODIMENTS

Hereinafter, an embodiment of the invention will be described in detail with reference to the accompanying drawings.

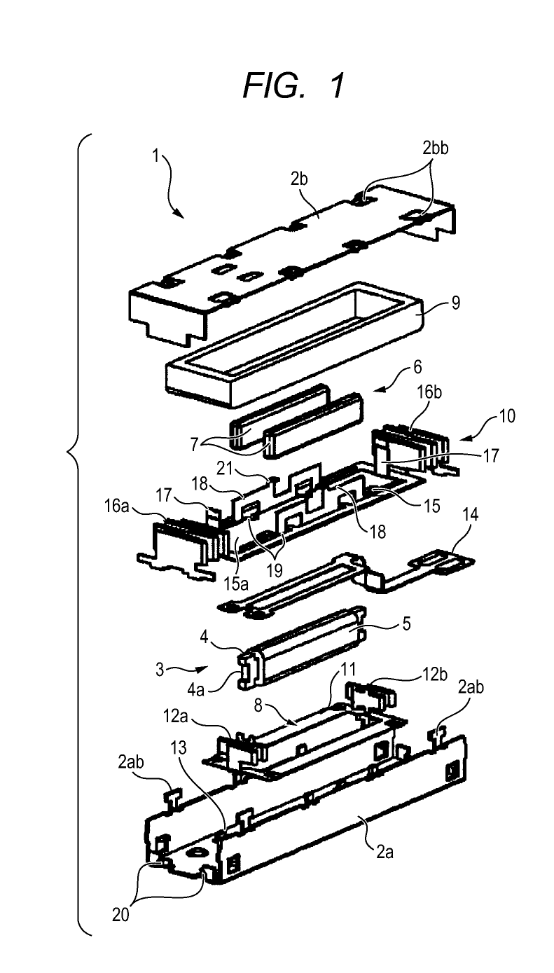

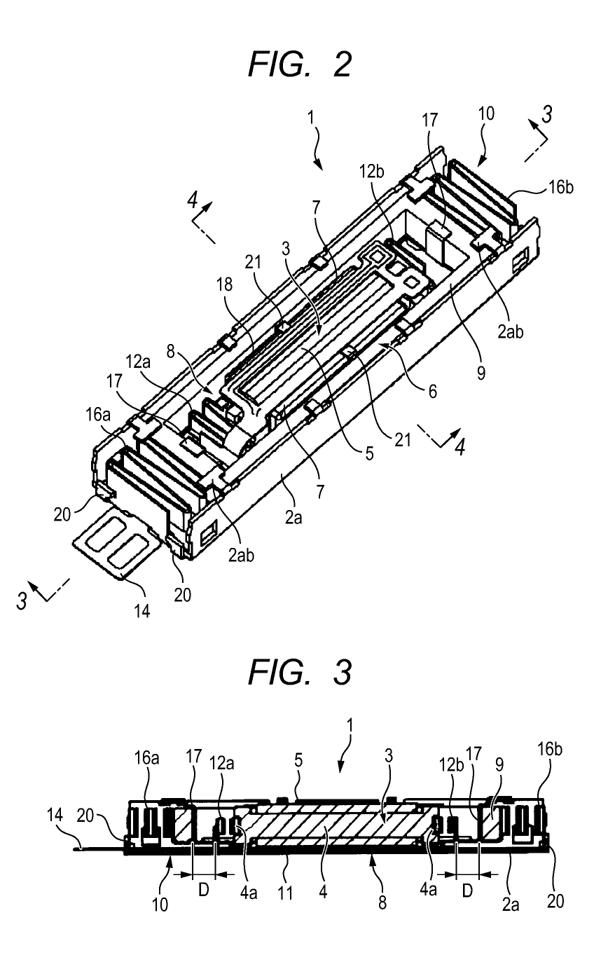

FIGS. 1 to 5 show a first embodiment of the invention.

A vibration generating device 1 of this embodiment is produced by assembling various components as shown in FIG. 1 in a rectangular housing 2 having an oblate hollow shape so that two kinds of vibrations with large frequencies are generated.

In this embodiment, in the housing 2, there are provided a coil 5 wound around the outer peripheral surface of a core 4, a first vibrator 3 vibrating due to a magnetic field generated at the coil 5, a magnetic field forming unit 6 having a pair of magnets 7, 7 oppositely disposed at both surfaces of the first vibrator 3 so that the same polarities face each other, a first elastic support member 8 for supporting the first vibrator 3 (both end portions of the core 4 in a length direction, in this embodiment) so that the first vibrator 3 is capable of freely vibrating, a second vibrator 9 connected to the magnetic field forming unit 6 so as to vibrate by receiving a repulsive force of interaction between the magnetic field generated by the coil 5 and the magnetic field generated by the magnetic field forming unit 6, and a second elastic support member 10 for supporting the second vibrator 9 (both end portions thereof in this embodiment) so that the second vibrator 9 is capable of freely vibrating. Also, the vibrating directions of the first vibrator 3 and the second vibrator 10 are set to be parallel to a fixed surface of the device (the bottom surface of the housing 2) so that vibrations having different frequencies are generated by the first elastic support member 8 and the second elastic support member 10.

Next, each component will be described additionally.

The housing 2 is integrally formed by covering a lower case 2a having an upwardly U-shaped cross section in a width direction with an upper case 2b having a downwardly U-shaped cross section in a length direction so that a plurality of protrusions 2ab formed on the sidewall of the lower case 2a caulk a plurality of engaging concave portions 2bb formed in a top board of the upper case 2b by bending. The lower case 2a and the upper case 2b are produced by pressing stainless steel foil. The bottom surface of the lower case 2a becomes a fixed surface of the device.

In this embodiment, each component is assembled by caulking, including other components.

Next, each component will be described in the order of assembly.

Firstly, the first elastic support member 8 is firmly fixed onto the lower case 2a. The first elastic support member 8 includes a thin and long rectangular base 11 at a center portion, and leaf springs 12a and 12b formed to stand up from both end portions of the base 11 in a length direction and bent a plurality of times into a bellows shape in a vibrating direction of the first vibrator 3 (in a length direction of the housing 2), and the first elastic support member 8 is formed by pressing and bending a stainless steel foil. The first elastic support member 8 carries the base 11 onto the lower case 2a, and a protrusion 13 formed to stand on the lower case 2a is bent for caulking.

The first vibrator 3 is formed by winding a coil 5 around the outer peripheral surface of a core 4 having a rectangular cross-sectional shape so as to have a rectangular cross-sectional shape, and the first vibrator 3 is supported and mounted in a hollow by respectively fitting the inner end portions of the leaf springs 12a and 12b of the first elastic support member 8 into concave portions 4a and 4b formed at end portions of the core 4 in a length direction, and then crushing the concave portions 4a and 4b for caulking As mentioned above, the first vibrator 3 is supported in the housing 2 by the first elastic support member 8 and is capable of vibrating in parallel to the fixed surface of the device (the bottom surface of the housing 2).

Next, one end of a FPC 14 having a current-applying circuit for applying current to the coil 5 is connected to a terminal of the coil 5, and the other end of the FPC 14 is attached to the outer portion of the housing 2 to protrude therefrom. A current applied from an external power source to the FPC 14 is controlled.

Next, the second elastic support member 10 is firmly fixed onto the lower case 2a. The second elastic support member 10 includes a thin and long rectangular base 15 at a center portion, bellows-shaped leaf springs 16a and 16b standing up from both outer end portions of the base 15 in a length direction and bent a plurality of times into a bellows shape in a vibrating direction of the first vibrator 3 (in a length direction of the housing 2), second vibrator fixing protrusions 17 and 17 respectively standing up from both inner end portions of the base 15 in a length direction, magnet fixing protrusions 18 and 18 respectively standing up from both inner end portions of the base 15 in a width direction, and magnet supporting base protrusions 19 and 19 respectively laterally protruding from both inner end portions of the base 15 in a width direction, and the second elastic support member 10 is formed by pressing and bending a stainless steel foil. The second elastic support member 10 carries the base 15 onto the lower case 2a, and the second elastic support member 10 is mounted to the lower case 2a by supporting both end portions in a length direction in a hollow by means of the leaf springs 16a and 16b in accordance with the way that the protrusion 20 standing on the end portion of the lower case 2a in a length direction is bent to caulk the external end portion of the leaf springs 16a and 16b. The base 15 has an opening 15a sized so that the first vibrator 3 and one pair of magnets 7 and 7 may be inserted therein.

Next, in order to form the magnetic field forming unit 6, one pair of magnets 7 and 7 is disposed at both surfaces of the first vibrator 3 to face each other, is inserted between the coil 5 and the magnet fixing protrusions 18 and 18 in a state in which the same polarities face each other, is carried onto the magnet supporting base protrusions 19 and 19, and then is caulked by bending a claw 21 protruding on the magnet fixing protrusions 18 and 18.

Next, a rectangular cylindrical balance weight 9 that forms the second vibrator 9 is carried onto the base 15 of the second elastic support member 10, and the upper end portions of the second vibrator fixing protrusions 17 and 17 are bent for caulking In this way, one pair of magnets 7 and 7 and the second vibrator 9 are integrally supported by the second elastic support member 10 of which both end portions in a length direction are supported in a hollow by the leaf springs 16a and 16b and mounted in the lower case 2a, and the second vibrator 9 may freely vibrate in parallel to the fixed surface of the device (the bottom surface of the housing 2). An interval D (see FIG. 3) between the second vibrator fixing protrusions 17 and 17 and each leaf spring 12a and 12b is formed to allow vibrations of each leaf spring 12a and 12b and the first vibrator 3 in the length direction and vibrations of each leaf springs 16a and 16b and the second vibrator 9 in the length direction.

Finally, the upper case 2b is caulked to the lower case 2a as mentioned above to complete the assembly.

Next, operations of this embodiment will be described.

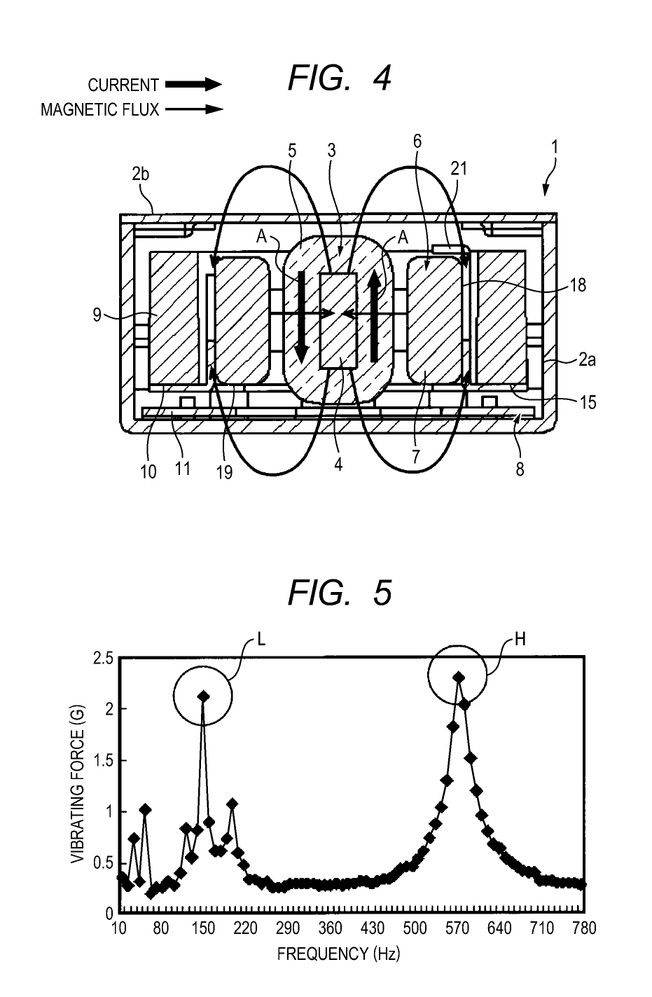

As shown in FIG. 4, if a current is initially applied to the coil 5 through the FPC 14, a current flows in the coil 5. Here, the current contributing to the vibration of the first vibrator 3 is the current flowing in a thickness direction of the coil 5 (see arrow A in FIG. 4). Due to the current applied to the coil 5, a magnetic flux oriented in the length direction of the core 4 is generated in the core 4.

The magnetic flux facing away from one pair of magnets 7 and 7 oppositely disposed at both side surfaces of the coil 5 of the first vibrator 3 and installed so that the same polarities face each other progresses toward the center of the core 4 in a direction orthogonal to the current flowing in a reverse direction to each arrow A direction at both sides of the core 4. By means of these two orthogonal currents and magnetic fluxes, vibrating forces in the same direction for vibrating in the length direction of the first vibrator 3, in other words in parallel to the fixed surface of the device (the bottom surface of the housing 2) are generated.

The magnetic flux formed in the core 4 progresses in the core 4 in the length direction and moves out of the core 4. At this time, so that the magnetic flux in the core 4 may progress in the length direction more easily, the first elastic magnetic support member 8 having the leaf springs 12a and 12b is made of stainless steel that is a magnetic material. Also, so that the magnetic flux may easily flow through the magnets 7 and 7, the lower case 2a and the second elastic support member 10 are made of stainless steel that is a magnetic material. Thus, the magnetic flux passes from the end portion of the core 4 through the leaf springs 12a and 12b, the first elastic support member 8, the lower case 2a, the leaf springs 16a and 16b, and the second elastic support member 10 in order and then flows through the magnets 7 and 7 easily.

In order that this magnetic flux may easily circulate and flow through, the magnetic flux facing away from each magnet 7 and 7 stably progresses toward the coil 5, and the first vibrator 3 vibrates with a large vibrating force in the length direction of the core 4, in other words in parallel to the fixed surface of the device (the bottom surface of the housing 2) together with each leaf spring 12a and 12b. In this case, since the first vibrator 3 formed by the core 4 and the coil 5 has a significant weight, it is possible to achieve stable vibrations, a simple structure and reduced costs.

In addition, the balance weight 9 that is the second vibrator 9 vibrates in the length direction of the core 4, in other words in parallel to the fixed surface of the device (the bottom surface of the housing 2) together with the leaf springs 16a and 16b, the second elastic support member 10, and the magnets 7 and 7 by receiving a repulsive force of interaction between the magnetic field generated by the current applied to the coil 5 and the magnetic field generated by the magnets 7 and 7. Since the balance weight 9 and the magnets 7 and 7 have significant weights, this vibration becomes largely stabilized.

In addition, in this embodiment, since the first elastic support member 8 and the second elastic support member 10 are entirely separately installed, their respective vibrations are not offset but respectively made with large vibrating forces, and the vibrations are made with different resonance frequencies. In detail, as shown in FIG. 5, the vibrations of the first vibrator 3 and the leaf springs 12a and 12b have high frequency (see the region H of FIG. 5), and the balance weight 9 and the leaf springs 16a and 16b have low frequency (see the region L of FIG. 5). Also, the vibrating force G at each resonance frequency has an increased peak shape in comparison to other frequency regions.

In this embodiment, the current applied to the coil 5 is an alternating current of the resonance frequency. In a case in which vibrations are made with one frequency, an alternating current of the corresponding frequency is applied, while, in a case where vibrations are made with both frequencies, an alternating current in which alternating currents of both frequencies are composed is applied.

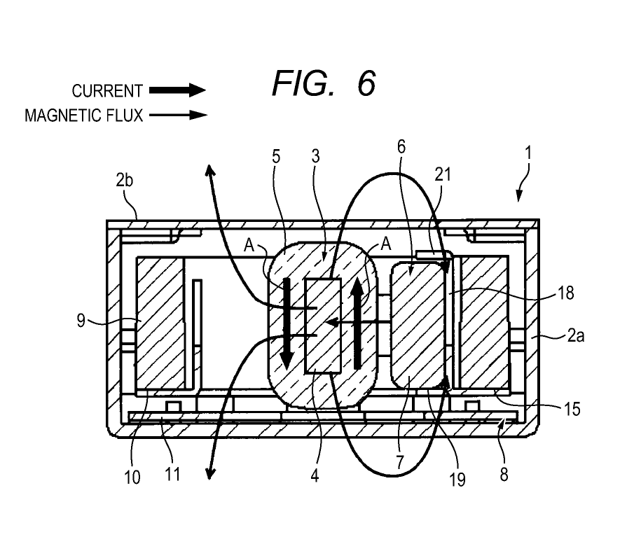

FIG. 6 shows another embodiment of the invention.

In this embodiment, only one magnet 7 is installed. Other configurations are identical to the former embodiment.

In this embodiment, a magnetic flux from one magnet 7 progresses toward the center of the core 4 in a direction orthogonal to the current flowing in the coil 5 just adjacent thereto in the arrow A direction. Due to the orthogonal currents and magnetic fluxes, a vibrating force for vibrating the first vibrator 3 in the length direction is generated. The subsequent progression of the magnetic flux, which moves in the core 4, is identical to that of the former embodiment.

In this embodiment, a leak magnetic flux from the core 4 is mixed at the region of the coil 5 opposite to the magnet 7 to generate vibrations in a direction opposite to the direction of vibrations generated by the magnet 7, but the core 4 and the coil 5 vibrate satisfactorily since the leak magnetic flux has a weaker intensity than the magnetic flux of the magnet 7.

In addition, in each embodiment, if vibrations by the second vibrator 9 and the second elastic support member 10 are not necessary, the vibration generating device may be formed without the second vibrator 9 and the second elastic support member 10.

Thus, according to the invention, since the magnet 7 of the magnetic field forming unit 6 is disposed at the side surface location of the vibrator 3, it is possible to decrease the size of the entire configuration in a thickness direction and increase vibrations in the length direction of the core 4, namely in parallel to the fixed surface of the device (the bottom surface of the housing 2).

In addition, vibrations having two kinds of frequencies or one kind of frequency may be increased in the length direction of the core 4, in other words in parallel to the fixed surface of the device (the bottom surface of the housing 2).

In addition, since the elastic support members 8 and 10 are configured with the leaf springs 12a, 12b, 16a, and 16b bent into a bellows shape in a direction orthogonal to the thickness direction of the vibrator, it is possible to decrease a size of the entire configuration in the thickness direction and increase vibrations in the length direction of the vibrators 3 and 9.

In addition, the invention is not limited to the above embodiments, and the invention may be modified as necessary.

It should be understood by those skilled in the art that various modifications, combinations, sub-combinations and alterations may occur depending on design requirements and other factors insofar as they are within the scope of the appended claims of the equivalents thereof.

What is claimed is:

1. A vibration generating device comprising:
a coil wound around an outer peripheral surface of a core;
a vibrator vibrating due to a magnetic field generated by the coil;
a magnetic field forming unit having a pair of magnets oppositely disposed at both surfaces of the vibrator so that the same polarities face each other or one magnet disposed at one side surface of the vibrator; and
an elastic support member for supporting the vibrator so that the vibrator is capable of freely vibrating,
wherein a vibrating direction of the vibrator is set to be parallel to a fixed surface of the device, by means of a magnetic flux generated by the magnetic field forming unit.

2. A vibration generating device comprising:
a coil wound around an outer peripheral surface of a core;
a first vibrator vibrating due to a magnetic field generated by the coil;
a magnetic field forming unit having a pair of magnets oppositely disposed at both surfaces of the first vibrator so that the same polarities face each other or one magnet disposed at one side surface of the vibrator;
a first elastic support member for supporting the first vibrator so that the first vibrator is capable of freely vibrating;
a second vibrator to which the magnetic field forming unit is connected and which vibrates by receiving a repulsive force caused by interaction of the magnetic fields; and
a second elastic support member for supporting the second vibrator so that the second vibrator is capable of freely vibrating,
wherein vibrating directions of the first vibrator and the second vibrator are set to be parallel to a fixed surface of the device, and vibrations with different frequencies are generated in accordance with the first elastic support member and the second elastic support member.

3. The vibration generating device according to claim 2, wherein the first elastic support member and the second elastic support member are made of a spring member bent a plurality of times, at least one end of which is fixed to a housing, at least another end of which is connected to the first vibrator or the second vibrator.

4. A vibration generating device comprising:
a housing; and
a vibrator supported in the housing by an elastic support member so that the vibrator is capable of freely vibrating, the vibrator vibrating due to a propulsive force generated by a magnetic field,
wherein the elastic support member is made of a spring member bent into a bellows shape in a vibrating direction of the vibrator.
